(19) United States
(12) Patent Application Publication
(10) Pub. No.: US 2008/0050191 A1
(43) Pub. Date: Feb. 28, 2008

(54) Chamfer tool

(76) Inventor: Bryan L. Catlin, Albion, NY (US)

Correspondence Address: LITMAN LAW OFFICES, LTD., P.O. BOX 15035, CRYSTAL CITY STATION, ARLINGTON, VA, 22215, US

(21) Appl. No.: 11/892,657

(22) Filed: Aug. 24, 2007

Related U.S. Application Data
(60) Provisional application No. 60/840,053, filed on Aug. 25, 2006.

(51) Int. Cl. B27G 15/00

(52) U.S. Cl. 408/231

(57) ABSTRACT

The chamfer tool is a deburring tool that can be power driven to debur a bolt or stud that has been cut off with, e.g., a cutting tool or torch. The tool comprises a spherical sectioned cutting head. The tool has a plurality of arcuate triangular cutting formations spaced out over a predetermined number of intervals around the circumference of the tool's cutting head. Preferably, five of the arcuate triangular cutting formations are disposed at approximately 72° intervals. A plurality of slanted L cutting formations are disposed within the spherical section of the cutting head to fill cutting voids created by the spacing of the arcuate triangular cutting formations. With this measure, a deburring tool is provided, which can perform a rounding off process without the occurrence of damaging stud threads.

### CROSS-REFERENCE TO RELATED APPLICATION

This application claims the benefit of U.S. Provisional Patent Application Ser. No. 60/840,053, filed Aug. 25, 2006.

### BACKGROUND OF THE INVENTION

1. Field of the Invention

The present invention relates to a chamfer, i.e., deburring tool adapted for rounding off the end of bolt threadings.

2. Description of the Related Art

Oftentimes a workpiece may be comprised of a bolt having the head sheared or torched off. This may create sharp edges and/or burrs on the remaining stud near the end of the stud thus preventing the application of a nut to the stud. Additionally, these sharp edges can be hazardous. For example, when an assembler tries to thread a nut onto a stud that has not been deburred, hand injury may result due to sharp stud burrs that the assembler may come in contact with. As mentioned before, the burrs can be problematic in that they may prevent the stud from properly accepting a nut.

Moreover, a stud having burrs may result in an undesirable appearance of the stud.

While hand filing of the burrs may be possible, the process is slow and may add to cost due to injury and lost time.

Additionally, related art deburring tools currently available typically cause a collapse in the threading near the filing area, thereby causing additional work to fix the threading.

Thus a chamfer tool solving the aforementioned problems is desired.

### SUMMARY OF THE INVENTION

The chamfer tool relates to a deburring tool that can be power driven to debur a bolt or stud that has been cut off with, e.g., a cutting tool or torch. The tool comprises a spherical sectioned cutting head. The tool has a plurality of arcuate triangular cutting formations in the cutting head and spaced out over a predetermined number of intervals around the circumference of the tool's cutting head. Preferably, five of the arcuate triangular cutting formations are disposed at approximately 72° intervals. A plurality of slanted L shaped cutting formations are disposed within the hemi-spherical section of the cutting head to fill cutting voids created by the spacing of the arcuate triangular cutting formations. With this measure, a deburring tool is provided, which can perform a rounding off process without the occurrence of damaging stud threads.

These and other features of the present invention will become readily apparent upon further review of the following specification and drawings.

### BRIEF DESCRIPTION OF THE DRAWINGS

FIG. 1 is a perspective view of the chamfer tool, according to the present invention.

FIG. 2 is a front view of the chamfer tool, illustrating a deburring pattern, according to the present invention.

FIG. 3 is a side view of the chamfer tool, according to the present invention.

FIG. 4 is a rear view of the chamfer tool, according to the present invention.

FIG. 5 is a side view of an alternative embodiment of the chamfer tool, according to the present invention.

FIG. 6 is a rear view of the alternative embodiment of the chamfer tool, according to the present invention.

Similar reference characters denote corresponding features consistently throughout the attached drawings.

### DETAILED DESCRIPTION OF THE PREFERRED EMBODIMENTS

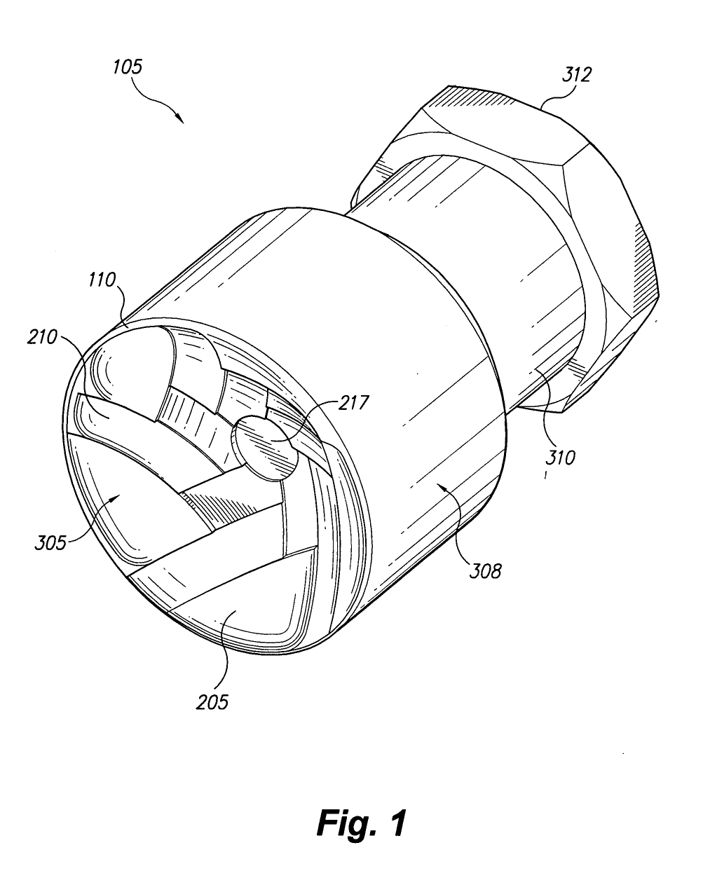

As shown in FIG. 1, the present invention is a deburring tool 105 having a cutting head 305 that presents a cutting surface end and a rear that presents a power tool attachment end. The configuration of the cutting head 305 of the tool is set so that the cutting action does not fold metal of a workpiece bolt down into its threads, thereby saving time after bolt finishing with the tool 105. That is to say, the threads do not have to be reformed by the use of a special nut upon completion of bolt chamfering with the tool 105.

As shown in FIGS. 1-3, a cavity shaped in the form of a spherical section, i.e., cutting head 305 extends inwardly from the face of the tool 105 to a cutting depth R. The spherical section wall of the cutting head 305 is shaped to form a plurality of cutters. Advantageously, the configuration of the cutters permits a user to shape the bolt or stud without the aforementioned undesirable effects on the threads.

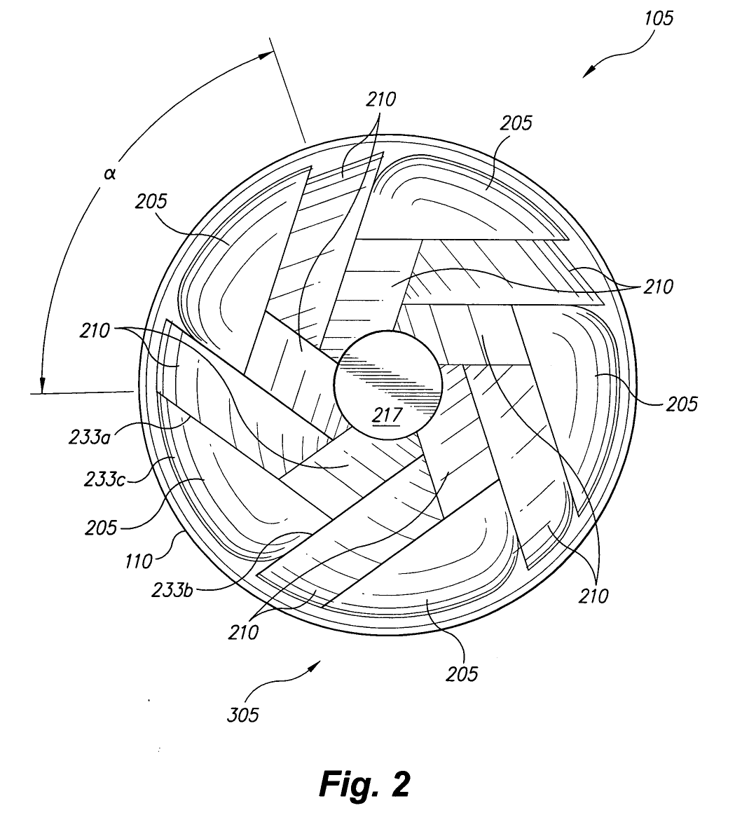

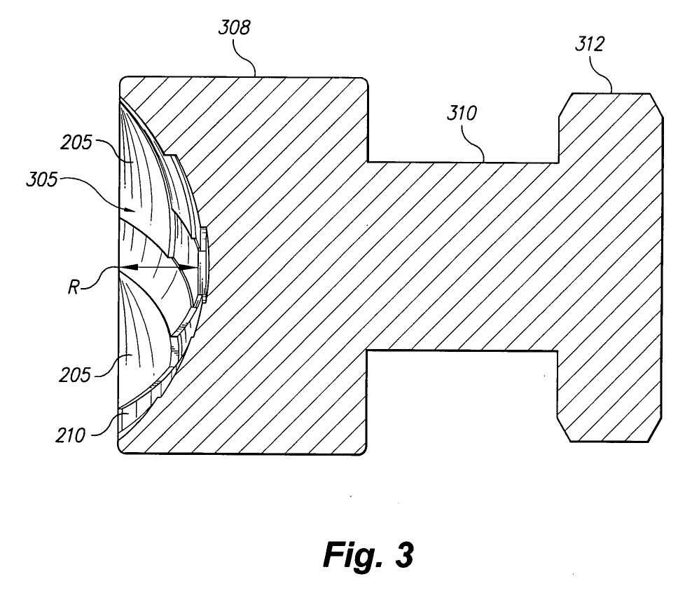

As shown in FIG. 2, the cutters are arranged in a specific pattern according to the shape of the cutter. At least two cutter types are formed in the spherical section of the cutting head 305. As most clearly shown in FIGS. 2 and 3, a first cutter type 205 is formed along the circumference 110 of the cutting head 305. The first cutter type comprises a plurality of arcuate, triangular shaped cutting edge formations that are disposed on the cutting head 305 at predetermined intervals having one of the edges of the formation disposed around the circumference 110 of the spherical sectioned cutting head 305. A first side of the triangular shaped cutting edge formation 205 is an arcuate cutting edge 233a that extends away from the face circumference 110 and forms a first predetermined sub segment of a chord that cuts into the cutting head 305 within a first half of the spherical section defined by the cutting head 305.

A second side of the arcuate triangular shaped cutting formation 205 is a second arcuate cutting edge 233b that extends away from the face circumference 110 and forms a second predetermined sub segment of a second chord that cuts into the face within a second half of the spherical section defined by the cutting head 305. Preferably, cutting edge 233b is of lesser length than cutting edge 233a. The third cutting edge is an arc along or proximate to the outer circumference 110 of the face of the tool 105 that subtends lines 233a and 233b.

This arcuate triangular cutting formation is repeated to form a plurality of arcuate triangular cutting formations in the cutting head 305 and spaced out over a predetermined number of intervals around the outer circumference 110 of the face of the cutting head 305. The interval spacing α of the arcuate triangular cutting formations is preferably approximately 72°, thereby creating 5 of the arcuate triangular cutting formations 205.

A second type cutting formation, such as slanted L cutting formation 210, is repetitively disposed within the spherical section of the cutting head 305, to fill cutting voids created by the spacing of the arcuate triangular cutting formations 205. Preferably, there exist no cutting surfaces in a region immediately proximate the axial center of the spherical sectioned cutting head 305. This region may have a cylindrically shaped depression 217 that is coaxial to the axial center of the cutting head 305 in order to facilitate seating the tool 105 on a stud or bolt to be deburred.

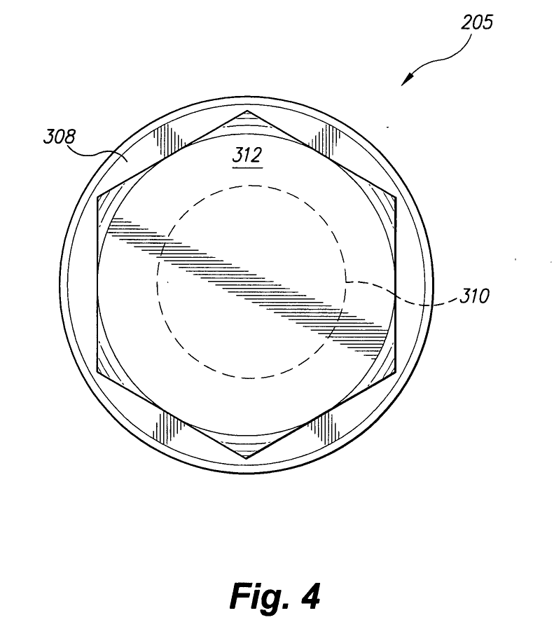

As shown in FIGS. 1 and 3, the tool body 308 is substantially cylindrical and extends rearward of the cutting head 305 for a first predetermined distance until it adjoins a narrower cylindrical midsection 310. The cylindrical midsection 310 extends for a second predetermined distance before adjoining a wider rear section boss 312. As shown in FIG. 4, rear section boss 312 can have a hexagonal shape so that the tool 105 may be received by a chuck of a power tool (not shown), or the like. The configuration of midsection 310 and rear section boss 312 allows the tool 105 to wobble axially and laterally while engaged in the power tool to facilitate the deburring process.

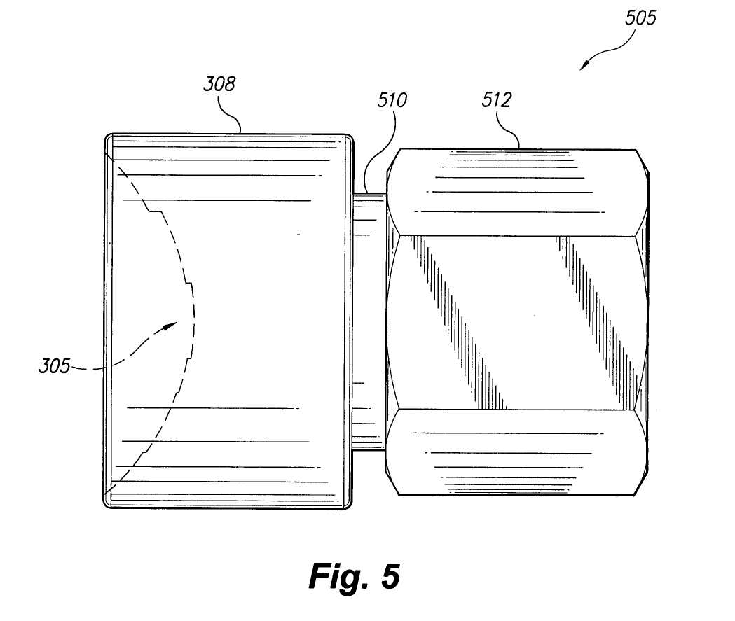

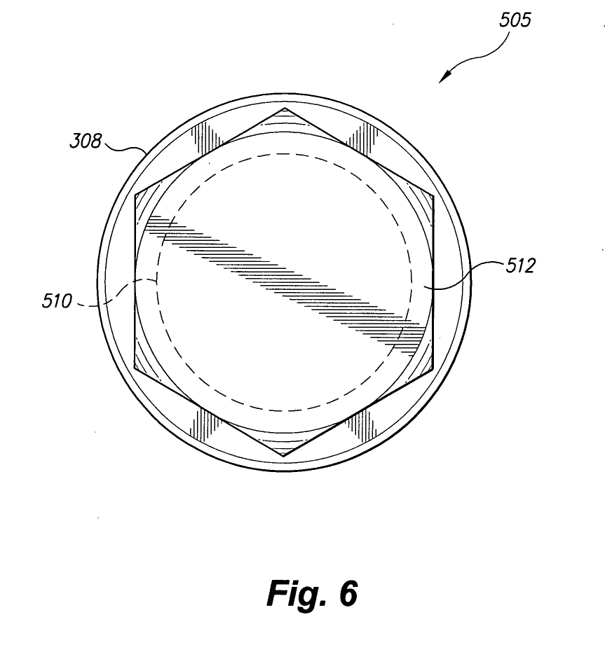

In an alternative embodiment 505 of the tool, as shown in FIGS. 5 and 6, alternative cylindrical midsection 510 extends a much smaller distance than previously described midsection 310, thus creating a stubby midsection 510 and a rear section boss 512 that is more elongated and wider than the previously described rear section boss 312. The alternative embodiment tool 505 preferably has the same cutting pattern as described for tool 105. Unlike the configuration of cylindrical midsection 310 and rear section boss 312, of tool 105, the configuration of stubby midsection 510 in combination with rear section boss 512 of alternative tool 505 does not permit axial or lateral wobble. Thus tool 505 is preferably used when deburring work is desired in tight areas.

It is to be understood that the present invention is not limited to the embodiment described above, but encompasses any and all embodiments within the scope of the following claims.

I claim:

1. A chamfer tool, comprising:
a spherical sectioned cutting head, the cutting head having a plurality of arcuate triangular cutting formations disposed within the cutting head and spaced out over a predetermined number of intervals around a circumference of the cutting head, the cutting head further having a plurality of slanted L-shaped cutting formations disposed within the cutting head to fill cutting voids created by the spacing of the arcuate triangular cutting formations; and
a tool body extending rearwardly from the cutting head, the tool body extending into a narrower midsection, the narrower midsection extending into a wider rear section attachment boss.

2. The chamfer tool according to claim 1, wherein the midsection extends into the wider rear section attachment boss is to a length substantial enough and a girth narrow enough to be adapted for axial and lateral movement of the tool when the tool is engaged with a receiving power tool chuck.

3. The chamfer tool according to claim 1, wherein the midsection extends into the wider rear section attachment boss to a length short enough and a girth wide enough to be adapted for preventing axial and lateral movement of the tool when the tool is engaged with a receiving power tool chuck.

4. The chamfer tool according to claim 1, wherein the rear section attachment boss has a hexagonal shape to facilitate being received by a chuck of a power tool.

5. The chamfer tool according to claim 1, wherein the predetermined interval spacing of the arcuate triangular cutting formations spans approximately 72°, thereby forming five intervals of cutting formations around the cutting head circumference.

6. The chamfer tool according to claim 1, wherein each of the arcuate triangular cutting formations comprises:
a first side arcuate cutting edge extending away from a circumference of the cutting head and forming a first predetermined sub-segment of a chord cutting into the cutting head within a first half of a spherical section defined by the cutting head; a second side arcuate cutting edge extending away from the cutting head circumference and forming a second predetermined sub-segment of a second chord cutting into the face within a second half of the spherical section defined by the cutting head; and
a third cutting edge defining an arc proximate to the outer circumference of the face of the tool, the arc subtending the first and second chord sub-segments.

7. The chamfer tool according to claim 1, further comprising a region immediately proximate the axial center of the spherical sectioned cutting head, the region having no cutting surfaces.

8. The chamfer tool according to claim 7, wherein the region having no cutting surfaces includes a cylindrically shaped depression coaxial to the axial center of the cutting head in order to facilitate seating the cutting tool on a stud or bolt to be deburred.
